(19) United States
(12) Patent Application Publication
(10) Pub. No.: US 2005/0240309 A1
(43) Pub. Date: Oct. 27, 2005

(54) Method and device for influencing a multiaxial manipulator

(76) Inventor: Rainer Bischoff, Augsburg (DE)

Correspondence Address: MCGLEW & TUTTLE, PC, P.O. BOX 9227, SCARBOROUGH STATION, SCARBOROUGH, NY, 10510-9227, US

(21) Appl. No.: 11/111,382

(22) Filed: Apr. 21, 2005

(30) Foreign Application Priority Data
Apr. 24, 2004 (DE) 102004020099.8

(51) Int. Cl. G06F 19/00

(52) U.S. Cl. 700/245

(57) ABSTRACT

A method for influencing a multiaxial manipulator, such as a multiaxial industrial robot, with a manually guided influencing device, whose position and location in space are measured and used for influencing the manipulator, is characterized in that in alternation movements of the influencing device and associated movements of the manipulator are performed. Through the proposed breaking down of the rotor movement into short partial movements influenceable in each case by the influencing device, despite unavoidable imprecisions of the sensor means used, it is possible to achieve a precise, reliable and intuitive influencing, particularly programming of robots.

### FIELD OF THE INVENTION

The invention relates to a method for influencing or controlling a multiaxial manipulator, such as a multiaxial industrial robot, with a manually guided influencing or control device, whose position and location in space is measured and is used for influencing or controlling the manipulator. The invention also relates to a device for influencing or controlling a movement of a multiaxial manipulator, such as a multiaxial industrial robot, whose position and location in space can be determined by a sensor means contained.

### BACKGROUND OF THE INVENTION

Multiaxial manipulators, such as multiaxial industrial robots, hereinafter called robots for short, are nowadays operated and programmed with the aid of large and relatively heavy, cable-attached manipulators. In order to bring about a manual displacement or travel of the robot and associated therewith the making efficient of the teaching of machining points, an operator must control a plurality of different coordinate systems, such as world, base and tool coordinates, so that without training and/or well-grounded background knowledge no-one is really in a position to displace and/or program such robots.

In order to master this problem, it has already been proposed in the past to program and/or control in a quasi-intuitive manner robots using a manually guided influencing device. Thus, DE 32 23 896 A1 discloses a scanning device for producing programs for path-controlled industrial robots with which the path to be programmed is covered manually and the position and orientation thereof is stored in the form of electronic data by an evaluating device. The positions determined by the scanning device are converted into electrical data and transmitted on-wire or in wireless form to the evaluating device, in which the path-determining quantities are determined, transformed into data suitable for robot control and stored. In said scanning device for the determination of the position use is made of gyroscopes, accelerometers, optically acting means or balls which can be rolled on the path to be programmed. It is considered particularly disadvantageous that the precision of the position determination is inadequate in the long term as a result of the determining means used, so that such devices and programming methods performable with the aid thereof have not hitherto proved successful.

DE 38 10 054 A1 discloses a method and a device for guiding the movement of multiaxial manipulators, the movement guidance being subdivided into the presetting of successive translatory and rotational movements of the manipulator tool. Use is made of a guidance mechanism with a pistol-like casing, whose orientation produces a translation with a time-limited preset speed, whilst rotational movements are brought about by modifying the spatial angular position of the guidance device. It is considered particularly disadvantageous that the described subdivision into translatory and rotational movements is not very intuitive and a further limitation results from the indicated preset speed.

The sensor means used once again leads to inadequate precision of the position determination in the long term.

It is also known from DE 100 48 952 A1 for the recording of coordinates of space points during a time-optimized, precise determination of the spatial situation of a robot to detect reference marks with the aid of a sensing device equipped with optical sensors and then to determine the sensing device position by image processing. However, the use of image-processing sensor means, which are relatively imprecise in this connection is disadvantageous.

The problem of the invention is to provide a method and a device of the aforementioned type with which the manual displacement and programming of robots, particularly the teaching of points and paths can be carried out easily and intuitively by an operator, particular importance being attached to the influencing precision achieved, particularly against the background of the safety regulations to be respected when using such manipulators.

### SUMMARY OF THE INVENTION

In the case of a method of the aforementioned type this problem is solved in that in alternating manner movements of the influencing device and associated movements of the manipulator are performed. In the case of a device of the aforementioned type, the set problem is solved in that it is provided with a monitoring device for monitoring an inaccuracy of measurement of the position determination sensor means. Thus, according to the invention, an overall movement of the robot to be preset is composed of several partial movements and in each case movements of the influencing device are only carried out for as long as the precision of the sensor means used in the inventive device is adequate during teaching. This obviates the indicated disadvantages of known methods and devices, so that unlike in the prior art it is possible to reliably influence or control the robot.

According to a further development of the inventive method, the position of the influencing device is measured by an internal sensor means located within the device, or the position of the influencing device is measured by an external sensor means located outside the device. Preferably there is a continuous monitoring of the inaccuracy of measurement of the sensor means used for position measurement purposes. Thus, in the method according to the invention it is possible to restrict the influencing of the robot to time periods in which it is possible to adequately precisely determine positions through the influencing device. Preferably there is also a predetermination of a time sequence of the alternation between movements of the influencing device and movements of the manipulator through measurement inaccuracies of the sensor means used. In other words movements of the influencing device can only influence the robot if the sensor means used allows an adequately precise determination of the position of the influencing device. If this is no longer the case, according to the invention the associated movements of the manipulator can take place until once again the influencing device allows a reliable, precise influencing of the manipulator.

In this connection and according to a highly preferred further development of the inventive method, on reaching a preset value for the measurement inaccuracy a necessary calibration of the sensor means used is indicated and optionally an influencing of the manipulator by the influencing device is prevented. Thus, there is regularly a calibration of the influencing device, i.e. the sensor means used therein, so that as a result of the inventive alternation between movements of the influencing device and movements of the manipulator it is possible to achieve an optimum reliable, precise influencing of a robot. Preferably the alternation from a movement of the influencing device to a movement of the manipulator takes place by operating an approval device. This preferably takes place manually by an operator.

Appropriately during a method according to the invention simultaneously positions or position changes in all movement-relative degrees of freedom of the manipulator are determined, so that intuitively by moving the influencing device complete influencing of the robot exists.

If vital significance is not attached to a specific movement path of the robot, it is possible to only determine a starting and an end position of the influencing device. It is then possible according to a further development of the inventive method for the associated movement of the manipulator to take place along a predetermined type of path, e.g. a linear or circular path, between manipulator positions in each case associated with the starting and end position of the influencing device. Further possible path types are spline-like paths, collision-free paths (with the aid of an environmental model or suitable, additional sensor means) or the like and finally paths which can be composed from path segments known to the robot control (approximation of a continuously recorded path by means of available path instructions). However, it is alternatively possible during the movement of the influencing device to continuously determine positions thereof, so that the associated manipulator movement takes place along a substantially randomly designed path determined in accordance with the detected positions. Thus, an operator can comprehensively and directly influence a robot movement path.

In an extremely preferred development of the inventive method, additionally further parameters associated with a manipulator position such as an action force on a workpiece to be machined can be determined by the influencing device. The measured positions and the further specified parameters of the influencing device, such as a course of a movement including speeds and accelerations, can then be used for producing a program for the movement control of the manipulator and/or for the direct operation thereof. Thus, according to the invention, it is possible to influence manipulators by gesture recognition.

According to other further developments of the inventive method, the influencing device is calibrated to the manipulator to be influenced by connection thereto, the manipulator then moves up to a predetermined sequence of space points and then position measured values of the influencing device are related to the known position values of the manipulator. It is also possible for the planned influencing of the manipulator, such as a selection of an operating mode and/or axes to be traversed, for specific gestures described by the influencing device to be detected and to be correspondingly transformed for influencing the manipulator.

In order to position and orient in a particularly sensitive and precise manner the manipulator, according to a highly preferred development of the method, by means of the influencing device there is a scaling of the movement of the manipulator in space and/or time. Additionally it is possible to limit the influencing of the manipulator by means of the influencing device to a specific number of degrees of freedom.

According to a further development of the device according to the invention, the sensor means is contained within the device and preferably use is made of inertial sensor means, which from the design standpoint can be constructed simply, inexpensively and in space-saving manner. Alternatively the sensor means can be positioned outside the device and preferably for determining movements of the device there are external sensors positioned outside the device and which are connected to a control unit of the manipulator and/or to a computing unit of the device. The external sensors can be cameras, laser triangulation systems (“constellation”), ultrasonic sensors, etc. The influencing device may then have to be supplemented by suitable marks or receivers/transmitters, which support or even make possible the external measuring method. For the comprehensive influencing of the overall movements of the robot, the sensor means used is preferably constructed for the simultaneous determination of positions in all degrees of freedom of the manipulator movement.

According to the invention, on exceeding predetermined parameter values for the inaccuracy of measurement, in accordance with the monitoring device, no manipulator influencing is possible. Thus, as soon as the sensor means used in the influencing device as a result of a sensor drift no longer reaches the accuracy or precision necessary for robot control, the influencing possibility for an operator is prevented so as to maintain adequate operational security. In order to subsequently reduce the inaccuracy of measurement, an inventive device preferably has a calibrating device.

In order to permit an intuitive handling or manipulation of the inventive device, it has at least one geometrically recorded preferred direction, such as a tip, point or the like. In this connection it is particularly appropriate to have a pencil-like construction of the device.

According to an extremely preferred development, the inventive device additionally has a measuring device in order to determine contact forces or moments acting on the device when in contact with an object. Whilst incorporating the data obtained through the additional measuring device, the inventive device can additionally be used for a robot movement control in view of machining processes to be performed.

The measured data of the device, i.e. position data and optionally force action data, are preferably usable for same time movement guidance of the manipulator, i.e. the robot can be guided online in accordance with the influencing device through the action of an operator. Additionally or alternatively the measured data of the device can be used offline for producing movement programs for the manipulator, preferably in a corresponding robot control device. Thus, movement sequences performed by means of the device according to the invention, can be permanently used for controlling robots.

In order to enable an operator to safely and easily use the inventive device, according to a further development the latter preferably has operating, control and indicating devices for selecting and monitoring the different operating modes (online or offline influencing, calibrating, etc.). These can in particular be voice recognition means and/or operator guidance means, particularly for interactive guidance by acoustic and/or optical signals.

In order to permit flexible usability of the inventive device with different robots/control units, according to a highly preferred development, the device has a computer unit for processing measured data into control data for the manipulator. In a further development, the inventive device is preferably constructed by means of a transmitting device for transmitting data to the manipulator or its control system, transmission preferably taking place in wireless manner.

### BRIEF DESCRIPTION OF THE DRAWINGS

Further characteristics and advantages of the invention can be gathered from the following description of embodiments relative to the attached drawings, wherein show:

FIG. 1 A diagrammatic representation of a possible inventive device construction.

FIG. 2 A diagrammatic representation of the binding of an inventive device to a robot control.

FIG. 3 Diagrammatically a possible construction of a sensor module of the inventive device.

FIG. 4a A preset pose for a robot using an inventive device.

FIG. 4b Robot movements associated with the preset pose of FIG. 4a.

FIGS. 5a, b The sequence of an inventive method as in FIGS. 4a, b, but with detailed path presetting for the robot using an inventive device.

FIGS. 6a, b, c Further possible robot movements on influencing by means of an inventive device.

FIG. 7 An inventive preset movement for a robot in a flow chart.

FIG. 8 An inventive preset coordinate system for a robot in a flow chart.

### DETAILED DESCRIPTION OF THE DRAWINGS

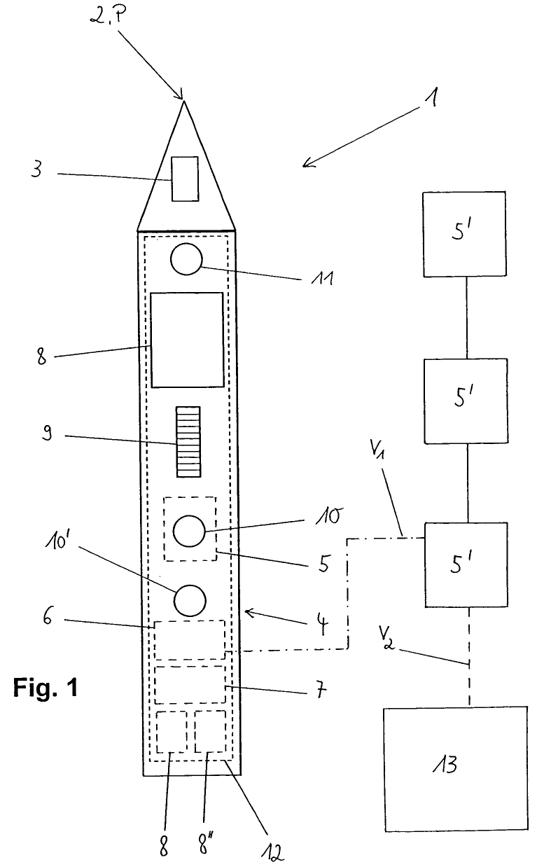

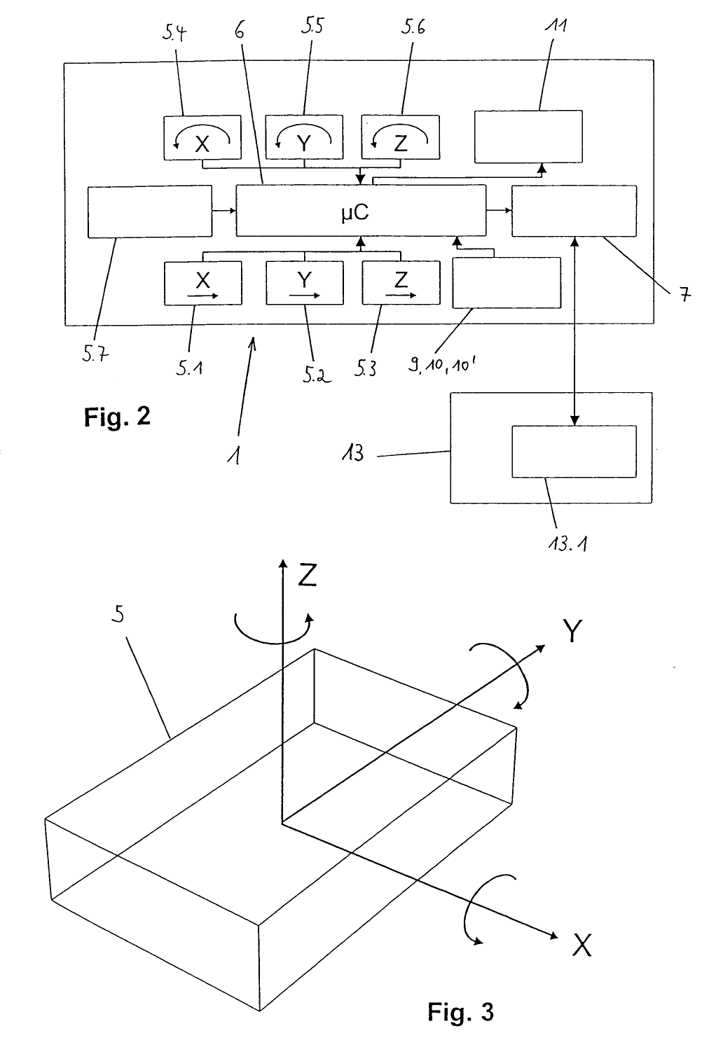

FIG. 1 diagrammatically shows a possible construction of the device according to the invention in the form of a pencil-like instrument 1. However, it is alternatively possible to construct the inventive device within a conventional robot operating device. However, it has been found that devices shaped in pencil-like manner, as a result of their characteristic, inherent preferred direction can be used particularly simply as intuitively employable influencing or control devices. Therefore the inventive device 1 has a point or tip 2, which coincides with a reference point R of device 1. In the vicinity of the tip 2 according to FIG. 1 the inventive device has a measuring device 3 in the form of a force-moment sensor, so that by means of the device 1 it is also possible to teach forces, e.g. action forces on a not shown workpiece. The lower, shaft-like part 4 of device 1, according to FIG. 1, comprises further functional, operating and indicating devices of device 1. The latter firstly has a sensor module 5, which is preferably constructed for determining translatory and rotational movements in six degrees of freedom, i.e. in three translatory and three rotational degrees of freedom, e.g. by means of accelerometers and gyroscopes (cf. FIG. 3), which is known to the expert. As will be made clear hereinafter, the method according to the invention, particularly allows the use of relatively imprecise and therefore inexpensive accelerometers, gyroscopes or similar imprecise measuring devices in the sensor module 5. The device 1 according to the invention also comprises a computing and memory unit 6, by means of which it is possible to process within the device 1 most of the preprocessing of the measured values (rough data) supplied by the measuring device 3 and sensor module 5 and which, according to the invention, is also set up as a calibrating device and a monitoring device for the measurement precision of the sensor module 5. However, it is also possible to transmit the rough data obtained by means of the measuring device 3 and sensor module 5 directly to a robot control 13 (cf. also FIG. 2).

Alternatively to the already described device-internal arrangement of the sensor module 5, according to the invention it is also possible to have external sensors 5′ for determining a position of the inventive influencing device 1 in space, as is also shown in FIG. 1. In the case of external sensors 5′, they can e.g. be cameras, laser triangulation systems, ultrasonic sensors, etc. In this case the device 1 has suitable marks and/or receivers/transmitters cooperating with the sensor 5′, which assist or make possible the corresponding, external position determination method. Such marks or the like are not shown in FIG. 1 so as not to overburden representation, but are obviously known to the expert.

The external sensors 5′ can be in operative connection either with the computing unit 6 of device 1 or with the robot control 13 and this is illustrated in FIG. 1 by a dot-dash connecting line V₁ or a broken connecting line V₂.

For data transmission purposes the device 1 according to the invention also has a transmission device 7, which can in particular be constructed as a radio module for wireless data transmission. The inventive device 1 also has a display 8, e.g. in the form of a LCD display or touch screen, with a first associated operating device in the form of a jog wheel 9, together with a microphone 8′ and loudspeaker 8″ operatively connected to suitable hardware and software devices (not shown) for a voice-control of device 1 by acoustic inputs and outputs. FIG. 1 shows further operating and control elements in the form of keys and/or pressure switches 10, 10′, together with an illuminating and/or indicating device 11, preferably in the form of a light emitting diode LED. Additional, per se known operating elements such as joysticks, tough pads, switches, etc. are possible, in order to create additional interaction possibilities for an operator with the inventive device 1. In place of a LED 11, as shown in FIG. 1, in the vicinity of the tip 2 can be concentrically arranged several light emitting diodes, in order to facilitate the fine positioning of a robot by targeted illumination of the environment.

Fundamentally a rotationally symmetrical body, such as the pencil shown, is only suitable to a limited extent for fixing six degrees of freedom, such as is necessary for influencing a multiaxial industrial robot. For an operator the rotation about the longitudinal axis (optionally axis of symmetry) of the pencil must remain optically detectable, i.e. there must not be an absolute rotational symmetry. This is achieved according to the invention in that the device 1 has specific operating and indicating elements (see above), clearly associating a back and front therewith and having the indicated tip 2, which serves for the detection of “top” and “bottom”.

Alternatively to the wireless connection of FIG. 1 between the inventive device 1 and a robot control (FIG. 2), there can naturally also be a cable connection, the cable preferably passing out at the lower end of the shaft-like part 4 of device 1 remote from the tip.

For power supply purposes, the device 1 according to the invention preferably has an internal power supply 12 in the form of a plurality of conventional batteries or accumulators. The inventive device 1 also preferably has a docking station (not shown), so that e.g. the accumulators of device 1 can be easily charged and also there is a safe storage location for device 1. The docking station can also provide suitable connections for transmitting and adjusting data between a robot control and the inventive device.

The docking station can be integrated into a conventional operating handset, even if only as a safe storage location or for power and data transmission to the influencing device. Further, by inserting the influencing device in the operating handset, the latter can be extended by numerous functionalities, e.g. position detection relative to an operator carrying said handset with respect to the robot. This can take place for safety reasons or also facilitates manual displacement by means of the spacemouse or displacement keys. Thus, e.g. in this way the tool coordinate system can be constantly oriented with respect to the operating handset with integrated influencing device in such a way that a deflection of the spacemouse to the “right” always brings about a displacement of the robot to the “right”. Therefore there is no need for the operator to notice the positioning of the tool coordinate system, but can instead assume that it always assumes a specific and preferably parallel angle to the operating handset.

By means of the computing and memory unit 6 contained in device 1, it is possible to store person-related data for the device usable by a robot control (FIG. 2) in order to identify operators and release or clear specific user rights on the basis of this identification. Thus, in its construction according to FIG. 1, the inventive device 1 is usable for storing user profiles (e.g. beginners or experts) and for authenticating operators.

In addition to the sensor means referred to, the sensor module 5 can have further sensor means, such as magnetic field sensors, temperature sensors, etc., which is known per se. Assuming a measurable, undisturbed magnetic field, such as the terrestrial magnetic field, with the aid of magnetic field sensors it is possible to determine in drift-free manner the orientation of the inertial measuring system contained in device 1, e.g. for calibration purposes.

By means of a block diagram, FIG. 2 once again shows the structure of the inventive device, particularly a device 1 according to FIG. 1, as well as the binding thereof to the robot control unit 13 (robot control). The functional elements of the inventive device 1 corresponding to FIG. 1 consequently carry the same reference numerals.

According to the invention, the robot control 13 has a transmission device 13.1 cooperating with the transmission device 7 of device 1. The computing unit 6 of device 1 shown as microcontroller μC in FIG. 2, receives signals from the sensor module 5 (FIG. 1), which according to FIG. 2 is subdivided into several individual sensors. There are e.g. three acceleration sensors 5.1-5.3 for accelerations in three spatial directions X, Y, Z perpendicular to one another, as well as three rotation rate sensors 5.4-5.6 for determining rotation rates about in each case one of said three spatial directions. FIG. 2 also shows as part of the sensor module 5 a further sensor 5.7, e.g. a temperature or magnetic field sensor, which is also connected to microcontroller μC. The microcontroller μC also receives (input) signals of the operating devices 9, 10, 10′ (cf. FIG. 1). Output signals of microcontroller μC pass via the transmission device 7, preferably a radio module, to the robot control 13 which, indicated by a double arrow in FIG. 2, is able by means of its transmission device 13.1 to communicate via the transmission device 7 of device 1 with the computing unit 6 thereof, e.g. in order to display robot-specific informations, selection menus or the like on the display unit 8 (FIG. 1) of device 1.

FIG. 3 diagrammatically shows a possible construction of the sensor module 5 of FIG. 1, which is constructed here for detecting accelerations and rotation rates in or around three spatial directions X, Y, Z which are orthogonal to one another. The sensors 5.1-5.6 used (FIG. 2) are known per se. They can in particular be known acceleration sensors, such as relatively inexpensive gyroscopes and/or electrostatic (capacitive) sensors which, as will be described hereinafter in conjunction with the description of the inventive method, can have a relatively imprecise measuring behaviour in the sense of a limited drift stability.

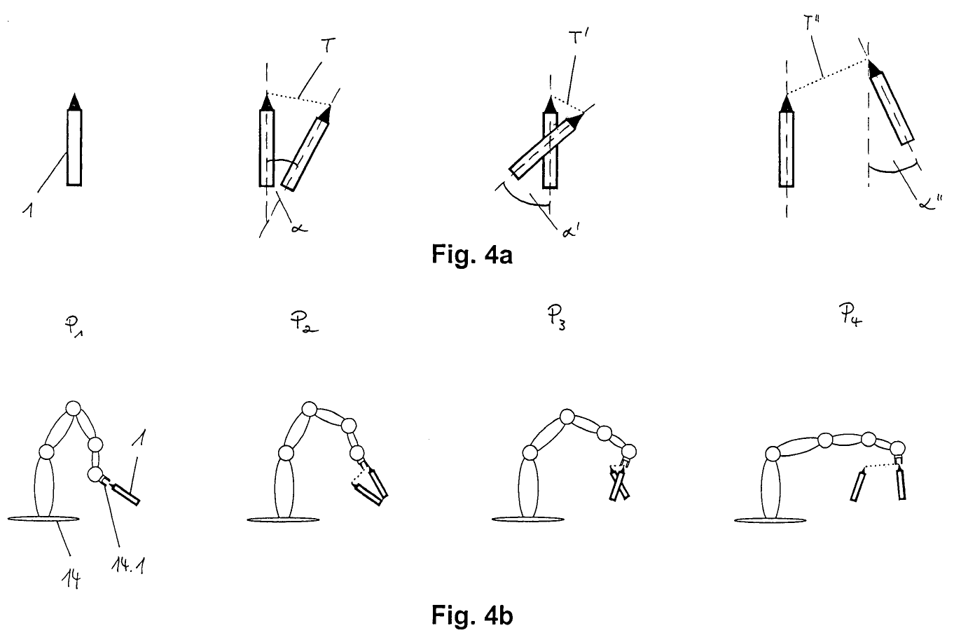

FIGS. 4a-8 show how the above-described, inventive device 1 can be used for influencing a manipulator, such as an industrial robot, in a method according to the invention. The inventive device 1, also called an influencing device hereinafter, is used for presetting movements of multiaxial machines, particularly for the manual displacement of robots with particular emphasis on the teaching of points and paths. The robot is moved by repeated alternation between a preset movement (preset pose) with the aid of the influencing device and a subsequent movement release for movement performance by the robot.

FIG. 4a, b illustrate how a robot 14, using the influencing device 1, can travel from its instantaneous pose (position and orientation) P₁ (to the left in FIG. 4b), via intermediate poses P₂, P₃ to a target pose P₄ (to the right in FIG. 4b), in that in alternating manner a movement is preset with the inventive device 1 (FIG. 4a) and an in each case associated movement of the robot 14 is performed (FIG. 4b). Generally the influencing device is manually controlled by a not shown operator. The preset movements shown in FIG. 4a using the inventive device 1 correspond (from the two-dimensionally projection thereof) translational movements T, T′, T″ (broken lines in FIG. 4a) associated with reorientations, particularly of a robot tool 14.1 or the tool centre point (TCP) of the robot 14, which is represented in FIG. 4a by rotating the device 1 about an angle α, α′, α″. As can be seen in FIG. 4a, b, according to the invention at the same time translational movements T-T″ and rotational movements α-α″ of the robot 14 are preset in the total movement degrees of freedom thereof with the aid of the influencing device 1.

As a measurement precision of the sensor means used in the inventive device 1 and/or a movement radius of the operator are generally not sufficient in order to preset the entire path of the robot 14 from the starting pose P₁ to the target pose P₄ in a single travel step, the complete movement is subdivided into several portions P₁-P₂, P₂-_{P}3, etc., a rapid alternation of a preset movement and a movement release being implemented with the aid of the device 1 and a movement implementation by the robot 14. Firstly the sensor means of the inventive device 1 is calibrated in its starting position (to the left in FIG. 4a), i.e. it is preferably “zeroed” (all position values set to zero). As the inventive device according to FIG. 2 communicates with the control 13 of robot 14, the device or its control in this way is aware of the relative pose of device 1 with respect to the robot 14 (cf. FIG. 4b), so that the position of a device 1 preferably held by an operator corresponds to the orientation and position of the TCP of the connected robot 14 (to the left in FIG. 4b). This is followed by a relative position change of device 1 in the direction of the target pose P4 and according to the construction shown in FIG. 4a, b no path information is recorded, i.e. only the positions P₁ and P₂ of the inventive device 1 are detected. The robot 14 is then caused to bring about the desired, associated pose change, e.g. relative to its TCP. The time left starting from pose P₁ until a target or intermediate pose is reached, here pose P₂, i.e. the time during which the preset movements for the robot 15 by means of device 1 are possible, corresponds to the time during which the unavoidable drift errors occurring with inexpensive sensors are ignored. It is in particular dependent on the nature of the movement performed with device 1. To this end the computing unit 6 of the inventive device 1 monitors the position and orientation imprecision occurring with the necessary double integration of the measured values supplied by the acceleration and rotation rate sensors 5.1-5.6 (cf. FIG. 2) and, when said time is reached, emits a signal with the aid of which the preset movement is stopped. This signal can e.g. be an optical or acoustic signal to an operator, so that the latter can break off a preset movement of free pieces. However, according to the invention, prior to the outputting of such a signal it is possible at any time for the operator to end a movement. However, it is also possible according to the invention to automatically record the target or intermediate pose reached at said time and correspondingly ignore further preset movements of device 1. However, preferably use is made of a combination of the two aforementioned constructions. Thus, according to the invention, it is possible to guarantee a desired precision of the robot movement in spite of the unavoidable sensor drift and the above-described alternation between preset movement and movement implementation takes place in accordance with the computing unit functioning here as a monitoring device.

For presetting the overall movement P₁-P₄ of robot 14 the device 1 is then moved over short path portions and then the robot is made to bring about the desired pose change. An operator is then directly or indirectly requested or forced to carry out repeated calibration, i.e. zeroing of the coordinate system of device 1 relative to the present pose of robot 14, so that the partial movements in each case have the necessary precision. This takes place in that:
the inventive device 1 or its computing unit 6 (microcontroller μC) accepts no other preset movement type than the combining of path segments, as described hereinbefore. However, the device 1 must be calibrated prior to each partial movement. The con clusion of a successful calibration is indicated to an operator, e.g. by the lighting up of a LED (cf. reference numeral 11 in FIG. 1), so that it is known as from what point in time a movement recording can commence;
after calibrating a specific path and/or a specific angle, the operator is requested to calibrate in at least one of the coordinate directions and different limit values can apply for paths and angles as a function of the measuring principle and sensor. The calibration request is e.g. indicated by LED or by the refusal of the necessary movement release (see below);
by a watchdog timer integrated into the computing unit 6 (FIG. 1) the operator is forced to carry out repeated calibration, which once again takes place e.g. by the extinguishing of the LED indicating a calibrated state of device 1 and/or by the refusal of movement release (see below).

After movement recording has taken place using the inventive device 1, as stated hereinbefore, it is necessary to release or clear the associated movement of robot 14. This preferably takes place in that the operator operates a mechanism within the inventive device 1, such as the keys 10, 10′ shown in FIG. 1 and corresponding to the approval key of a conventional operating handset. Movement release can be stopped and granted again at any time until the preset (partial) movement path has been completely covered or the movement performance has been completely stopped. Such a stoppage can e.g. take place by again zeroing the device coordinate system following a specific key depression, a voice control, a gesture or the like. When the preset movement has been given in the aforementioned manner, according to FIG. 4b the robot 14 either moves on the fastest possible path, a linear path or an environment-adapted (collision-free) path, so that e.g. the TCP undergoes a position change corresponding to the position change determined with the inventive device 1. Then, by means of the inventive device 1, a further path segment is recorded, a zeroing of the device 1 only being necessary if since the last zeroing a sufficiently long period of time has elapsed so that it must be assumed that the integrated inaccuracy of measurement would make unnecessarily difficult the operation or control of robot 14. After again releasing the movement the robot 14 passes into the next (intermediate) pose. If the target pose P₄ desired by the operator has still not been reached, a further path segment is recorded, optionally after once again zeroing device 1. On reaching the target pose P₄ this is taken over by corresponding input on the inventive device 1, e.g. by depressing one of the keys 10, 10′ and, optionally after processing in the computing unit 6 (FIG. 1, 2), is transmitted to the robot control 13, where it can be taken over in a robot control program.

The jog wheel 9 is used for presetting override, scaling or speed factors or for menu selection. For example, a forward rotation of jog wheel 9 can lead to an acceleration of the robot, whereas a rearward rotation slows the latter down. Many jog wheels also have integrated push button functions, which can be used for taking over points in a program or for accepting a pose reached, so as to reduce the size of the influencing device.

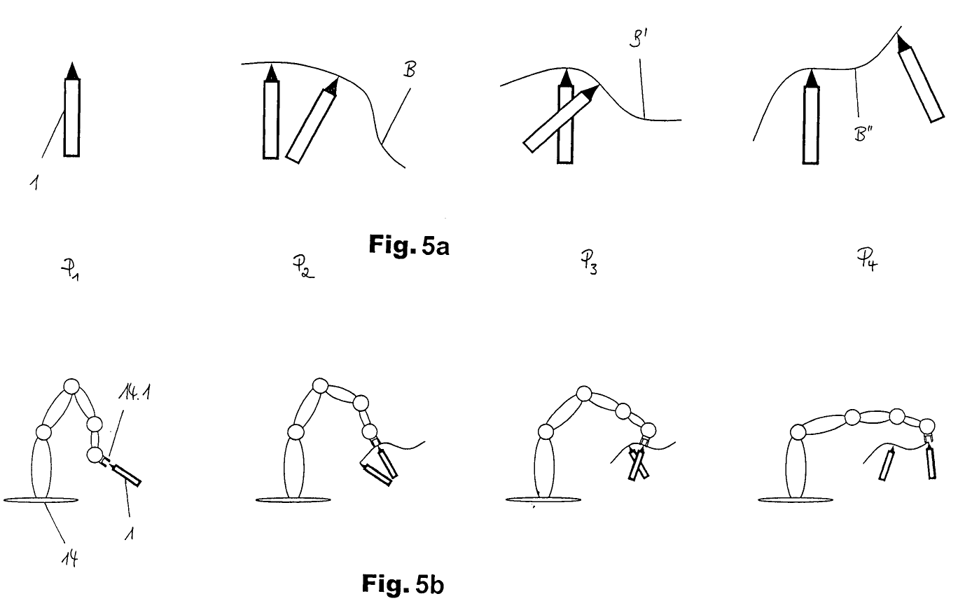

FIG. 5a, b show the movement of a robot 5 in several (target) poses P₁-P₄ by means of an inventive device 1 and path information concerning the movement path B, B′, B″ between the individual poses is recorded. The further travel sequence corresponds to that described hereinbefore relative to FIG. 4a, b, i.e. by means of the device 1 an operator alternatively presets poses or positions and consequently gives movement releases. According to the invention a recording of path information means that in accordance with a particular measuring cycle of the sensor means used or the microcontroller μC detection takes place of all the poses measured between the starting pose and the (intermediate) target pose, e.g. poses P₁, P₂, during the position change of the influencing device 1. Once again following a preset movement, the robot 14 moves on the indicated path B, B′, B″ in such a way that e.g. the position of the TCP changes in accordance with the position change of device 1. Optionally the robot control 13 (FIG. 2) manipulates the recorded part B, B′, B″ in an appropriate manner, e.g. by straightening, adapting to maximum speeds of the robot 14, etc. and files it e.g. in the form of a spline or several linear segments in a control program for the robot 14. If a covered path e.g. path B, proves unsuitable for a travel of robot 14, e.g. due to a threatening collision, the robot 14 automatically and/or as a result of key depression passes into the previous (target) pose, here pose P₁, so that a further path recording can commence. By means of operating or control devices integrated into the inventive influencing device or further, not expressly showed interaction forms, such as voice control or the like, it is fundamentally always possible to again manipulate, skip, extinguish, etc. all the already taught path segments.

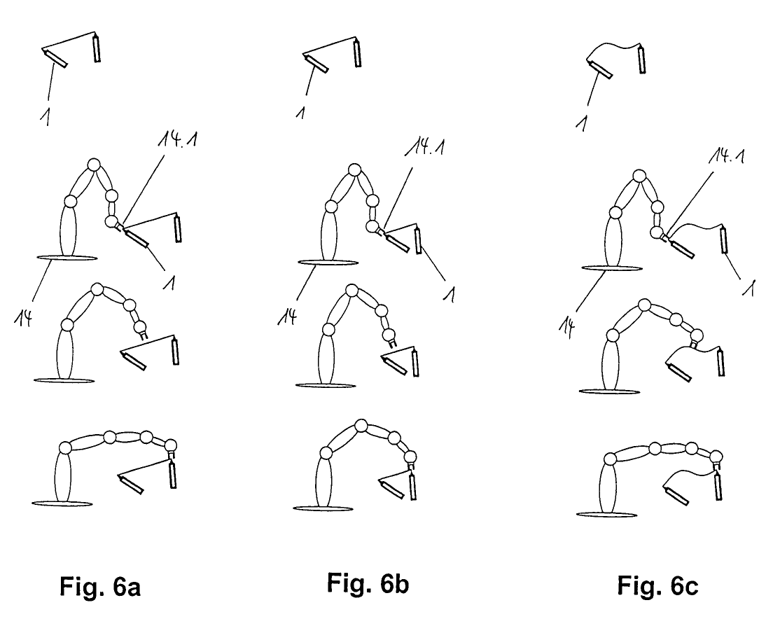

As shown in FIG. 6a-c it is possible to scale the complete robot movement to be performed with respect to space and time. To this end FIG. 6a-c shows the preset movement performed with the aid of the inventive device 1 in the top line of the representation and this is followed in time sequence from top to bottom by the associated movement states of the robot 14 or its tool 14.1 or TCP.

FIG. 6a shows a movement of the inventive device 1 from a starting to an end pose and (below) the associated, relative position change of robot 14 from a starting to an end pose with respect to the TCP, i.e. the tip of the tool 14.1. The position change of device 1, without scaling, is directly transformed into a corresponding position change of robot 14. The represented intermediate pose (third image from above in FIG. 6a) merely illustrates the robot movement.

FIG. 6b shows a movement of robot 14 using a scaling thereof. Whereas the preset movement performed with device 1 exactly corresponds to that of FIG. 6a, the robot travels on a much shorter path, as is readily apparent by comparing FIGS. 6a and 6b, i.e. the scaling factor used has a value smaller than one.

FIG. 6c shows a travel of robot 14 on a recorded path, but once again without scaling. Correspondingly and according to FIG. 6a and FIG. 6c the robot reaches an identical target pose (in each case bottom image of FIG. 6a, c).

As a result of the scaling proposed the robot 14 can be very sensitively positioned and oriented if the movement of the inventive device 1 is much greater than the actually performed movement of robot 14. However, in this way it is e.g. also possible to comfortably program a very large robot in that device 1 is only slightly moved, but produces a large, associated movement of the robot 14. In addition, the speed taken over in the robot control program can correspond directly to a corresponding speed of the previously performed movement. However, for the safety of an operator it is possible to limit the robot speed during the programming process to predetermined, permitted values. A final path speed and the associated accelerations can in the same way as the further limiting conditions also be adapted by a following programming process, e.g. corresponding inputs to a conventional operating or control device.

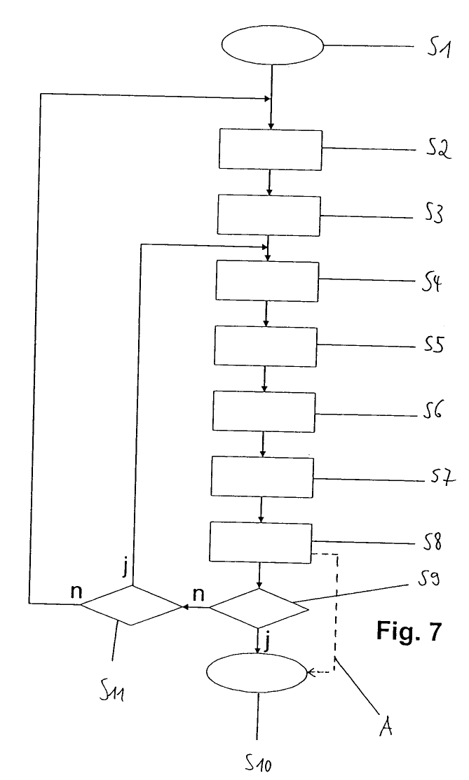

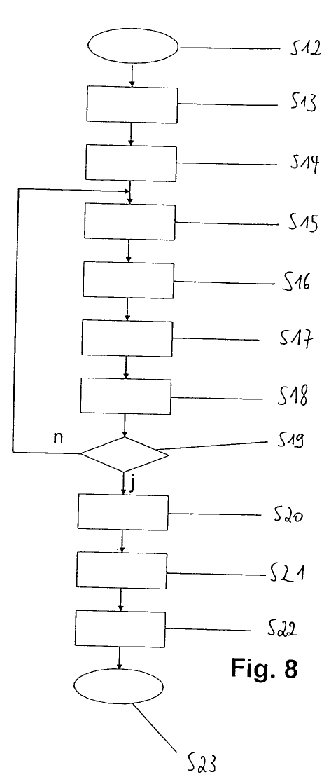

The above-described, relative preset movement by means of the inventive device 1 can optionally be restricted in a random manner, e.g. by restricting to a specific number of degrees of freedom of the movement, random combinations of rotational and translatory degrees of freedom or with respect to freely selectable and/or device-teachable coordinate systems. The inventive method for the sequence of a preset movement and a preset coordinate system will now be described in greater detail relative to the flow charts of FIGS. 7 and 8.

According to the invention a preset movement commences with step S1 according to FIG. 7. The inventive device 1 (cf. FIG. 1-6c) in step S2 is randomly held in space, typically in the vicinity of the TCP, because then the presentation of the travel process is easier for an operator. Following onto a start indication of the operator in step S3, the present position of the device and the robot pose are related to one another, i.e. their mutual relative position is determined. The start indication can take place manually, e.g. by depressing a key, by voice input or by a specific movement of the device (gesture recognition). Additionally or alternatively the start indication can be determined automatically, e.g. by proximity sensors on the robot or device or by intelligent movement detection, which then responds if the device has been stationary for a long period and then suddenly moves to a different position.

Then in step S4 the operator moves the inventive device in space and the path covered or the poses taken up on this path can be recorded (step S5). As a result of a stop indication corresponding to the start indication in step S6, the path recording is ended and the end pose of the device determined. When in step S7 the operator then gives the movement release, the robot can travel parallel to the indicated path in space or can automatically calculate and perform the desired, relative displacement movement (step S8) and optionally use is made of an offline planning system to avoid collisions. The operator can at any time withdraw the movement clearance and/or break off the already performed movement. This is illustrated by the broken line A in FIG. 7. Subsequently, in step S9, there is an inquiry as to whether the robot has assumed the desired pose. If this inquiry is affirmed (j), the sequence ends in step S10 and the end pose is optionally taken over in a robot control program. If not (n), the sequence is repeated until the robot has assumed the desired pose. This is followed in step S11 by an inquiry as to whether the above-described steps S2, S3 can be dropped. If the inquiry S11 is affirmed (j), the travel sequence is continued with step S4. Otherwise (n) continuation takes place with step S2.

Steps S2, S3 can in particular be dropped if
the last reached end point was achieved with an adequate precision,
the precision at this path point plays no part, or
the operator by deliberate or non-deliberate “incorrect” positioning of the inventive device has automatically compensated the accumulated errors of the sensor means contained there (FIGS. 1 to 3).

In these cases the last reached end point serves as the starting point for the new (partial) movement. Evaluations with respect to the movement precision can fall within the capacity of the operator, but are preferably at least jointly monitored by the inventive device.

By means of a flow chart, FIG. 8 shows in exemplified manner the presetting of a coordinate system with the aid of the inventive device. After starting the travel in step S12, the inventive device in step S13 is oriented against a reference coordinate system, e.g. by oriented superimposing of the device on the robot flange or on another device measured with respect to the robot. Following a start instruction of the operator in step S14 (cf. description of FIG. 7) the present poses of the device and the robot are related to one another, e.g. by zeroing or superimposing the values of TCP position and orientation. The operator then moves the device in space (step S15). In step S16 the path covered can be recorded. In step S17 as a result of a stop instruction corresponding to the start instruction path recording is ended and the end pose of the inventive device determined. From the now known starting and end poses of the device with respect to a known reference coordinate system the robot or its control in the following step S18 determines the precise end pose location. This is followed in step S19 by an inquiry as to whether an adequate number of points has been determined for establishing the desired coordinate system. If this inquiry is affirmed (j), then in step S20 the desired coordinate system is calculated. For example, the base coordinate system of a robot can be calculated on the basis of the position values of three points. However, using the device according to the invention it is possible to determine any random coordinate system, e.g. the TCP coordinate system in the case of tool measurement. Subsequently in step S21 the device is again oriented with respect to a reference coordinate system, as described in step S14. Then in step S22 and following onto a start instruction (see above) the operator compares the present poses of the device and robot in order to check whether the values from step S14 still coincide. This makes it possible to establish an error in determining the position of the coordinate system and to optionally compensate same by a correction calculation. The travel is then ended in step S23. However, if the inquiry is denied in step S19 (n), the present end pose is considered as the starting pose for the next movement and the travel continues with step S15.

The above-described method is also suitable for fixing movement planes or axes in space, within which the degrees of freedom of the robot are to be limited. For example, for the displacement of a specific axis or for the selection of an operating mode or movement parameter, the inventive device is randomly held in space and as a result of a start instruction of the operator, e.g. using voice recognition the first step is the recognition of a gesture. Whether the corresponding gesture is recognized or not can be indicated by the already mentioned LED at the tip of the device (cf. FIG. 1, e.g. colour change green/red), by peeping or by other suitable interaction elements. In the case of a voice output or using a display (cf. reference 8 in FIG. 1), it is possible using the inventive device to directly output which gestures are recognized and which operating mode has been set. However, the inventive device can also be constructed so as to guide the operator by the interaction. Thus, it is e.g. possible for the operator to select a robot axis, by writing in the air the number of said axis (as a digit) or to point to the axis to be covered. Particularly if the device is constructed for selecting a specific robot axis by pointing, a voice or number output on a display is advantageous, in order to provide the operator with continuous feedback regarding the axis being pointed to, before there is an axis selection, e.g. by key depression.

After selection has taken place, there is an adjustment of the present orientation of the inventive device in space, e.g. following a start instruction through the operator (see above). The device then serves as a type of lever, through whose rotation in space the selected axis is made to move. Thus, a “forward” movement (away from the operator) could mean a rotation of the axis in the positive sense, whereas a “rearward” movement could mean a rotation in the negative sense. The angular divergence of the device from its starting position can be used as a preset position (as described above also combinable and scalable from several partial movements), but also as a preset speed.

In the computing unit 6 of the inventive device 1 (FIG. 1) or in the robot control 13 (FIG. 2) optionally there can be an intelligent signal processing for the detection of gestures or for differentiating movements to be performed and resetting or other undesired movements. This is particularly appropriate
for the combining of partial paths during fine positioning/orientation,
for the automatic detection of resetting movements of the operator during fine positioning, so that the movement release can be simplified (no further key depression necessary) and
for providing safety for the operator in the case of “foolish” movements, e.g. due to the operator stumbling.

If interaction with the inventive device or the robot takes place by means of gesture recognition, as described hereinbefore, the inventive device can be given a small construction. Gesture recognition is particularly appropriate
for selecting known operating modes of the robot (test, automatic, calibration/teaching of coordinate systems, axial displacement) or the inventive device (rough positioning, fine positioning),
for selecting reference coordinate systems (world, ba se, tool),
for limiting movement performance to specific axes and planes (axis 1, XY-plane, YZ-plane, random plane or axis in space),
for selecting individual axes of the multiaxial robot by means of character recognition, e.g. by writing corresponding numbers in the air and
for presetting program parameters/movement instructions, such as linear, circular or fastest possible movement, for presetting speeds, accelerations, etc.

For the automatic calibration of the device according to the invention it is preferably oriented with respect to a reference coordinate system, e.g. by the oriented placing of the device on the flange of the robot to be subsequently programmed (cf. step S13 in FIG. 8). Following onto a start instruction from the operator or optionally automatically, the present poses of device and robot are co-related (cf. step S14 in FIG. 8). The robot together with the device then moves in accordance with a specific calibration program in space, so that continuously or at discreet spatial points from the path covered information can be gathered concerning the relationship between the measured value supplied by the device and the known robot poses. By means of this relationship the calculation specification used in the computing unit 6 of the device can be adapted for determining coordinates via scaling factors and parameters, e.g. for drift compensation in such a way that the device supplies correct path informations. The above-described method can also be used in order to set a specific scaling factor not equal to one. When using this method with a robot, which has a corresponding mounting support for receiving several inventive devices, in the case of a known offset of each device with respect to the reference point of the mounting support, calibration can simultaneously take place on all these devices.

### REFERENCE NUMERALS LIST

1 (Influencing) device
2 Tip
3 Measuring device
4 Shaft
5 Sensor module
5′ External sensor
5.1, 5.2, 5.3 Acceleration sensor
5.4, 5.5, 5.6 rotation rate sensor
5.7 Temperature/magnetic field sensor
6 Computing unit
7 Transmitting device
8 Indicating device
8′ Microphone
8″ Loudspeaker
9 Jog wheel
10, 10′ Key
11 Light emitting diode
12 Power supply
13 Robot control
13.1 Transmitting device
14 Robot
14.1 Robot tool
α,α′,α″ Angle
A Stop
B, B′, B″ Movement path
j Affirmed inquiry
n Denied inquiry
P Reference point
P₁ Starting pose
P₂, P₃ Intermediate pose
P₄ Target pose
S1-S23 Travel steps
T, T′, T″ Translational movement
V₁, V₂ Connection
X, Y, Z Spatial direction

1. Method for influencing a multiaxial manipulator, such as a multiaxial industrial robot, with a manually guided influencing device, whose position comprising a position and location in space is measured and used for influencing the manipulator, characterized in that in alternating manner movements of the influencing device and associated movements of the manipulator are performed.

2. Method according to claim 1, wherein the position of the influencing device is measured by means of an internal sensor means located within the same.

3. Method according to claim 1, wherein the position of the influencing device is measured by external sensor means located outside the same.

4. Method according to claim 2, wherein an inaccuracy of measurement of the sensor means used for position measurement purposes is continuously monitored.

5. Method according to claim 2, wherein a time sequence of the alternation between movements of the influencing device of the manipulator is preset by the measurement inaccuracy of the sensor means used.

6. Method according to claim 4, wherein on reaching a preset value for the measurement inaccuracy a necessary calibration of the sensor means used is indicated and optionally an influencing of the manipulator by the influencing device is prevented.

7. Method according to claim 1, wherein the alternation of a movement of the influencing device and a movement of the manipulator takes place after operating an approval device.

8. Method according to claim 1, wherein simultaneously positions or position changes in all movement-relevant degrees of freedom of the manipulator are detected.

9. Method according to claim 8, wherein only a starting and an end position are detected.

10. Method according to claim 8, wherein the associated movement of the manipulator along a predetermined type of path takes place between the manipulator positions associated with the starting and end positions of the influencing device.

11. Method according to claim 8, wherein during the movement of the influencing device positions thereof are continuously detected.

12. Method according to claim 11, wherein the associated manipulator movement takes place along a substantially randomly designed path determined in accordance with the detected positions.

13. Method according to claim 1, wherein additionally further parameters associated with a manipulator position, such as an action force on a workpiece to be machined are determined by the influencing device.

14. Method according to claim 1, wherein the measured positions and/or further parameters of the influencing device, such as a movement path including speeds and accelerations, are used for producing a program for the movement control of the manipulator and/or for the direct operation thereof.

15. Method according to claim 1, wherein the influencing device is calibrated with respect to the handling device to be influenced by connection thereto, the manipulator then moves up to a predetermined sequence of spatial points and then position measured values of the influencing device are related to known position values of the manipulator.

16. Method according to claim 1, wherein for the planned influencing of the manipulator, such as a selection of axes to be travelled and/or an operating mode, specific gestures described with the influencing device are recognized and correspondingly transformed for influencing the manipulator.

17. Method according to claim 1, wherein there is a scaling of the manipulator movement in space and/or time by means of the influencing device.

18. Method according to claim 1, wherein an influencing of the manipulator by means of the influencing device is limited to a specific number of degrees of freedom.

19. Device for influencing a movement of a multiaxial manipulator, such as a multiaxial industrial robot, whose position incorporates a position and location in space can be determined by means of sensor means, wherein a monitoring device for monitoring an inaccuracy of measurement of the position determining sensor means.

20. Device according to claim 19, wherein the sensor means is contained within the device.

21. Device according to claim 19, wherein the sensor means has an inertial sensor means.

22. Device according to claim 19, wherein the sensor means is located outside the device.

23. Device according to claim 22, wherein for detecting movements of the device there are sensors located outside said device connected to a control unit of the manipulator and/or a computing unit of the device.

24. Device according to claim 19, wherein on exceeding predetermined parameter values for the measurement inaccuracy in accordance with the monitoring device no influencing of the manipulator by means of the device is possible.

25. Device according to claim 19, wherein a calibrating device for reducing the measurement inaccuracy.

26. Device according to claim 19, wherein the sensor means is constructed for the simultaneous determination of positions in all degrees of freedom of the manipulator movement.

27. Device according to claim 19, characterized by means of at least one geometrically recorded preferred direction, such as a tip or the like.

28. Device according to claim 19, characterized by a measuring device for determining contact forces or moments acting on the device on contacting an object.

29. Device according to claim 19, wherein measured data of the device are usable for same time movement control of the manipulator.

30. Device according to claim 19, wherein measured data of the device can be used for producing movement programs for the manipulator.

31. Device according to claim 29, characterized by operating and indicating devices for selecting and monitoring different operating modes.

32. Device according to claim 19, characterized by a computing unit for processing measured data into control data for the manipulator.

33. Device according to claim 19, characterized by a transmitting device for transmitting data to the manipulator.

34. Device according to claim 33, wherein the transmitting device is set up for wireless transmission.

35. Device according to claim 19, characterized by voice recognition means and/or operator guidance means, particularly for interactive guidance by acoustic and/or optical signals.
